(19) United States
(12) Patent Application Publication
(10) Pub. No.: US 2018/0161670 A1
(43) Pub. Date: Jun. 14, 2018

(54) Single-Handed Input Controller and Method

(71) Applicant: Evgeny Boev, Vancouver (CA)

(72) Inventor: Evgeny Boev, Vancouver (CA)

(21) Appl. No.: 15/376,603

(22) Filed: Dec. 12, 2016

(51) Int. Cl. A63F 13/24

(52) U.S. Cl. CPC A63F 13/24; A63F 2300/1043

(57) ABSTRACT

A single-handed input controller includes a controller housing and a wrist fastener. The electronic controller is useful for controlling an electronic device with a single hand. The controller includes a plurality of finger-operated buttons for selecting a category of controls and a thumb-operated directional pad for selecting an individual control. The controller includes an aperture and an arm support for receiving an arm of the user such that the controller may be worn by the user without necessitating conscious grasping.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of electronic devices and more specifically relates to hand controllers.

### 2. Description of Related Art

An input device is a piece of computer hardware used to provide data and control signals to an electronic device such as a computer. Essentially, input devices facilitate interaction between a user and a device. Examples of input devices include keyboards, mice, scanners, and joysticks. Input devices can be classified by modality of input, degrees of freedom, discrete or continuous control, absolute or relative positioning, and direct or indirect input. Many commercial examples are composite input devices, which combine multiple forms of input.

Input devices are often unwieldy, requiring a stable platform to use, such as a keyboard, or necessitating the use of both hands. In addition, many composite input devices require many individual input devices to provide an adequate amount of controls for a desired function. These limitations make multi-tasking difficult, and may also limit a device's usefulness to disabled persons. A suitable solution is desired.

U.S. Pat. No. 5,764,164 to Michael C. Cartabiano et al. relates to an ergonomic hand-attachable controller. The described ergonomic hand-attachable controller includes an ergonomic hand-attachable controller for providing command signals to control movement of at least one object responsive to hand movement.

U.S. Pat. No. 5,444,462 to Mark L. Wambach relates to a computer mouse glove with remote communication. The described computer mouse glove with remote communication includes a glove worn on the hand of a computer operator providing a computer mouse function for a computer having a video display highlighted by a cursor, in which the apparatus senses the direction of movement of an element of a computer operator's body and transmits corresponding commands to the computer to move the cursor in the video display in a corresponding direction.

U.S. Pat. No. 9,389,684 to William B. Sebastian relates to a platform for finger controls. The described platform for finger controls includes a hand-mounted controller that allows a user to manipulate individual sensors associated with one or more, and typically each, of a wearer's fingers and thumb while monitoring movement of the controller in three-dimensional space.

None of the aforementioned publications provides a hand controller such as the input device of the present disclosure. Thus, a need exists for a reliable user input device to address the above mentioned problems.

### BRIEF SUMMARY OF THE INVENTION

In view of the foregoing disadvantages inherent in the known hand controller art, the present disclosure provides a novel single-handed input controller. The general purpose of the present disclosure, which will be described subsequently in greater detail, is to provide a single-handed input controller useful for allowing a user to remotely control a video game or other remotely operable electronic device with only one hand.

A single-handed input controller is disclosed herein including a controller housing and a wrist fastener. The controller housing may comprise an arm support configured to support an arm of a user, a hand aperture configured to receive a hand of the user, a thumb-operated directional control pad including four thumb-operated buttons, a plurality of finger-operated buttons, and an inner cavity structured and configured to fixedly retain at least one controller processor and at least one power source. The wrist fastener may be configured to fasten a wrist of the user to the arm support of the controller housing.

The controller housing may be ergonomically contoured such that the electronic controller is operable with a single hand of the user. The arm support and the wrist fastener of the controller housing may work in functional combination to allow the electronic controller to be retained and operated without the application of a grasping force by the user's hand. The electronic controller may be designed to be worn by the user on the arm, as the controller housing may be suspended from the hand of the user during use.

The controller housing may be contoured to ergonomically fit the hand of the user. The thumb-operated directional control pad and the plurality of finger-operated buttons may be designed to line up with the natural position of the thumb of the user and the fingers of the user when wearing the controller.

The electronic controller may be securely fastened to the arm of the user by use of the wrist fastener in combination with the arm support of the controller housing and the hand aperture of the controller housing. The thumb-operated control pad may be actuated by a thumb, and the finger-operated buttons may be actuated by fingers of the user. The thumb-operated directional control pad and the finger-operated buttons may be actuated simultaneously. Each button may actuate a different programmable command as registered and processed via the control processor.

The finger-operated buttons may be disposed longitudinally on the controller housing such that the user may operate the plurality of finger-operated buttons with all four fingers. The thumb-operated directional control pad may be arranged perpendicular to the plurality of finger-operated buttons, such that the user may operate the thumb-operated directional control pad via his or her thumb.

The controller processor may translate an input to an output, and may transmit an electronic signal to an auxiliary device by either wired or wireless means. Each of the finger-operated buttons may transmit a signal if pressed briefly. Further, each of the finger-operated buttons may transmit an alternative signal if pressed and held for a predetermined measure of time (for example, two seconds).

The signal transmitted by the controller may be dependent on the following sequence of user actions: pressing one of the finger-operated buttons of the controller housing, holding one of the plurality of finger-operated buttons for either a short or long period of time, and pressing one of the thumb-operated buttons of the thumb-operated directional control pad of the controller housing. Each of these actions may have an effect in determining the output signal, so that the total number of potential unique signals is increased by all three parameters. The thumb-operated buttons of the thumb-operated directional control pad may be assigned to unique signals. For example, if there are four finger-operated buttons each having two settings (press or press and hold for a measure of time) in addition to four directions on the direction pad, then the total number of potential output signals is a maximum of thirty-four (34).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a single-handed input controller, constructed and operative according to the teachings of the present disclosure.

FIG. 1 is a perspective view of the single-handed input controller, according to an embodiment of the disclosure.

FIG. 2 is a front view of the single-handed input controller of FIG. 1, according to an embodiment of the present disclosure.

FIG. 3 is a cutaway view of the single-handed input controller of FIGS. 1-2 illustrating the interior components of the controller, according to an embodiment of the present disclosure.

FIG. 4 is a perspective view of the single-handed input controller of FIGS. 1-3 in an ‘in-use’ condition, according to an embodiment of the present disclosure.

FIG. 5 is a flow diagram illustrating a method of use for using the single-handed input controller with a single hand, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to hand controllers and more particularly to a single-handed input controller as used to improve the remote controlling of an electronic device with a single hand.

The present disclosure describes an electronic input device useful for controlling remote controlled toys, video games, drones, robotic devices, and the like by hand. Another use of the single-handed input controller is as a typing device for visually handicapped users, in which each control may be a letter or number. The controller may be advantageous in that it allows for manipulation of a large selection of unique signals with the use of a single hand. The controller may incorporate a wrist strap and a large aperture to support itself from a user's hand, so that is worn similarly to a glove, and does not require conscious grasping on the part of the user. The controller may be manipulated by the use of several buttons, preferably one for each finger, and a four-way direction control pad, which may be engaged by a thumb of the user.

The housing of the controller may include a large aperture through which a hand of the user may be placed. The channel formed by the aperture may extend outwardly, forming a gutter-like support which may be placed beneath an arm of the user while in use. A wrist fastener may be mounted to the support which may be attached to both sides of the channel such that when the controller is worn by the user, the arm of the user may be secured between the support and the fastener. Preferably, the wrist fastener may comprise a strap including a spring which may automatically coil the fastener when not in use, and a button which may secure both ends of the fastener. To one side of the aperture, a cylindrical, hollow housing may be included, such that is falls within the grasp of the hand of the user.

The four finger-operated buttons may be mounted in a row longitudinally up the side of the cylindrical section of the housing and positioned such that buttons rest under a fingertip of each finger of the user (with exception of the thumb). Preferably, the buttons are curved to match the contours of the housing, and to comfortably match the bent fingers of the user during an ‘in-use’ condition. The directional control pad may be located at the top end of the cylindrical section, above and to one side of the aperture. In this way, the user's thumb may be rested upon the directional pad for convenient manipulation. Inside the cylindrical section of the housing an inner cavity may be included which contains a power source and a controller processor for providing operating power and programmable functionality to the electronic input device.

Functionally, the finger-operated buttons may not be electronically mapped to individual controls, but rather to a selection of controls which may be chosen from by use of the directional pad. In this way, a user may select a control by first pressing one of the finger-operated buttons, and subsequently pressing one of four directions on the directional pad to choose from the selected category of controls.

Additionally, further controls may be enabled by mapping two categories of controls to a single finger-operated button. The first category of controls may be selected by briefly pressing the finger-operated button, while the second category of controls may be selected by holding the finger-operated button for a predetermined period of time. In some embodiments, this predetermined measure of time may be adjustable by a user.

Therefore, a user may select a desired control by pressing one of the finger-operated buttons for either a brief or prolonged measure of time and subsequently pressing one of the directions of the directional pad.

In alternative embodiments, the controller may include a touchscreen display, and may be shaped for accommodating different hand positions, such as an open hand. Another embodiment may include a joystick instead of a directional pad. Various embodiments may feature a variety of button quantities and may include buttons of different ergonomic shapes.

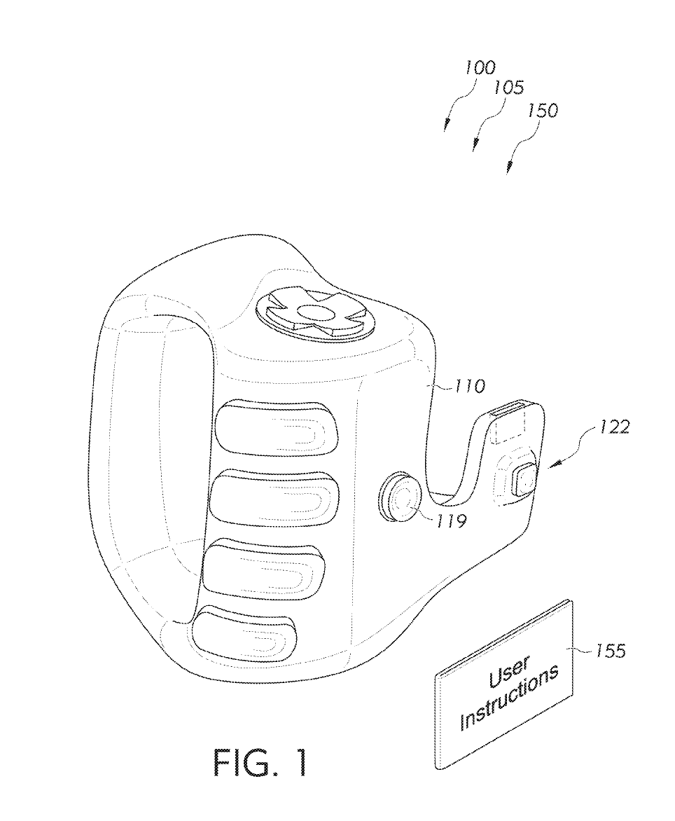

Referring now more specifically to the drawings by numerals of reference, there is shown in FIGS. 1-4, various views of a single-handed input controller 100. Referring specifically to FIG. 1, there is shown single-handed input controller 100 according to an embodiment of the present disclosure. Here, the electronic controller may be beneficial for use by a user 140 to control an electronic device with one hand. As illustrated, the single-handed input controller 100 may include controller housing 110 having arm support 111 configured to support arm 141 of user 140, hand aperture 112 configured to receive hand 142 of user 140, thumb-operated directional control pad 113 including four thumb-operated buttons 114, plurality of finger-operated buttons 115, inner cavity 116 structured and configured to fixedly retain at least one controller processor 117 and at least one power source 118, and power switch 119, and wrist fastener 120 configured to fasten wrist 143 of user 140 to arm support 111 of controller housing 110 having coil spring 121 and button-operated fastener 122.

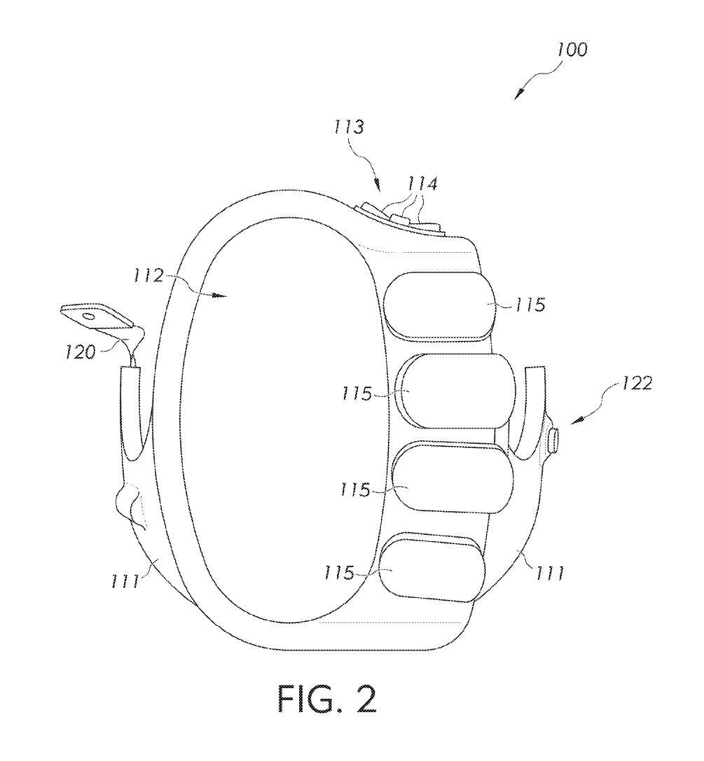

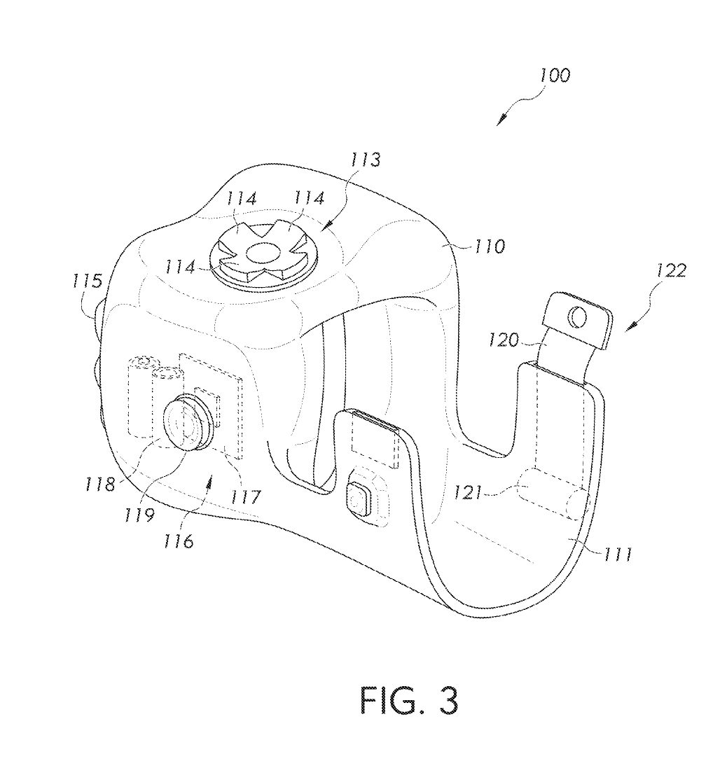

Referring now to FIG. 2, controller housing 110 of single-handed input controller 100 may be ergonomically contoured such that single-handed input controller 100 may be operable with single hand 142 of user 140. Arm support 111 and wrist fastener 120 of controller housing 110 may work in functional combination to allow controller housing 110 to be retained and operated absent application of a grasping force of single hand 142 of user 140. In such a manner, controller housing 110 is structured to receive and be worn by arm 141 of user 140 such that controller housing 110 may be suspended from hand 142 of user 140. Preferably, controller housing 110 is contoured to ergonomically fit hand 142 of user 140 such that thumb-operated directional control pad 113 of controller housing 110 and plurality of finger-operated buttons 115 of controller housing 110 is aligned with a positioning of thumb 144 of user 140 and fingers 145 of user 140 as is best shown in FIG. 3. Controller housing 110 may securely fastenable to arm 141 of user 140 via wrist fastener 120, arm support 111 of controller housing 110, and hand aperture 112 of controller housing 110 in functional combination.

In continuing to refer to FIGS. 1-4, thumb-operated directional control pad 113 of controller housing 110 may be operable via thumb 144 of user 140. Plurality of finger-operated buttons 115 of controller housing 110 may be operable via fingers 145 of user 140. Fingers 145 of user 140 may consist of pointer finger, middle finger, ring finger, and pinky finger.

In various instances of use of single-handed input controller 100, thumb-operated directional control pad 113 of controller housing 110 and plurality of finger-operated buttons 115 of controller housing 110 are operable simultaneously. Thumb-operated directional control pad 113 of controller housing 110 and plurality of finger-operated buttons 115 of controller housing 110 comprise input devices. Pressing any one of the input devices may trigger a unique signal to at least one controller processor 117. Pressing any combination of input devices may further trigger a unique signal to at least one controller processor 117. It should be appreciated that at least one controller processor 117 may transmit the unique signal to an electronic device (for example, a video game), and that each unique signal may correspond to a unique command or action of the electronic device.

Plurality of finger-operated buttons 115 of controller housing 110 may be disposed longitudinally on controller housing 110 such that user 140 may operate plurality of finger-operated buttons 115 of controller housing 110 with fingers 145. Thumb-operated directional control pad 113 of controller housing 110 may be arranged perpendicular to plurality of finger-operated buttons 115 of controller housing 110 such that user 140 may operate thumb-operated directional control pad 113 of controller housing 110 with thumb 144 of user 140.

FIG. 3 is a perspective view of single-handed input controller 100 illustrating inner cavity 116 of controller housing 110, according to an embodiment of the present disclosure. As shown, inner cavity 116 may fixedly retain at least one controller processor 117 and at least one power source 118.

At least one controller processor 117 may translate an input to an output. Single-handed input controller 100 may be structured and arranged to transmit an electronic signal to an auxiliary device by wired or wireless means via at least one controller processor 117. Each of plurality of finger-operated buttons 115 of controller housing 110 may transmit a first signal if pressed briefly, and a second signal if pressed and held for a predetermined measure of time.

In one embodiment, at least one power source 118 may comprise batteries which are rechargeable and alternatively non-rechargeable. Batteries may be AA batteries, AAA batteries, and the like. In other embodiments, at least one power source 118 may comprise a power connector. The power connector may include an external power cable which may be plugged into an outlet.

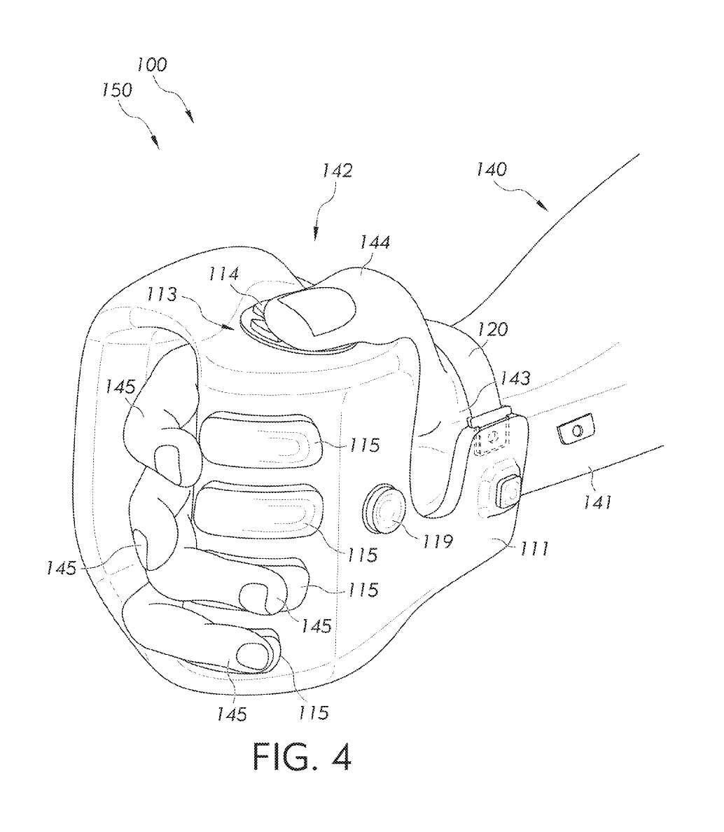

Referring now to FIG. 4 showing a perspective view of single-handed input controller 100 during ‘in-use’ condition 150, according to an embodiment of the present disclosure. As may be appreciated, the selection of an electronic signal may comprise: pressing one of plurality of finger-operated buttons 115 of controller housing 110, holding one of plurality of finger-operated buttons 115 of controller housing 110 for either a short or long period of time, or pressing one of four thumb-operated buttons 114 of thumb-operated directional control pad 113 of controller housing 110. The selection of the electronic signal may be dependent on the combination of these control parameters.

In one embodiment, the single-handed input controller 100 may be designed to ergonomically fit a right hand of user 140 that is right-handed. In another embodiment, the single-handed input controller 100 may be designed to ergonomically fit a left hand of user 140 that is left-handed.

According to one embodiment, the single-handed input controller 100 may be arranged as a kit 105. In the kit 105, the single-handed input controller 100 may include the single-handed input controller 100 and a set of operating instructions 155. The instructions 155 may detail functional relationships in relation to the structure of the single-handed input controller 100 (such that the single-handed input controller 100 can be used, maintained, or the like, in a preferred manner).

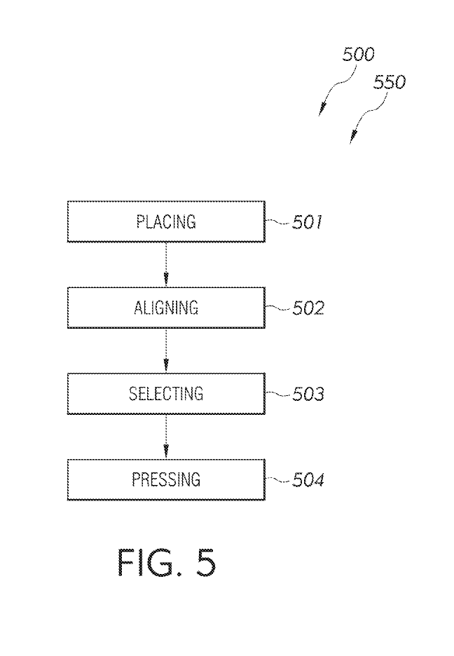

FIG. 5 is a flow diagram illustrating a method for controlling an electronic device with a single hand, according to an embodiment of the present disclosure. In particular, the method for controlling an electronic device with a single hand 500 may include one or more components or features of the controlling an electronic device with a single hand 100 as described above. As illustrated, the method for controlling an electronic device with a single hand 500 may include the steps of: step one 501, placing hand 142 through hand aperture 112 of controller housing 110; step two 502, aligning arm 141 with arm support 111 of said controller housing 110, fastening wrist fastener 120 about wrist 143; step three 503, selecting one of plurality of finger-operated buttons 115 of controller housing 110; and step four 504, pressing one of four thumb-operated buttons 114 of thumb-operated directional control pad 113 of controller housing 110.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for controlling an electronic device with a single hand (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electronic controller comprising:
a controller housing having;
an arm support configured to support an arm of a user;
a hand aperture configured to receive a hand of said user;
a thumb-operated directional control pad including four thumb-operated buttons;
a plurality of finger-operated buttons;
a power switch configured to activate and deactivate said electronic controller; and
an inner cavity structured and configured to fixedly retain at least one controller processor and at least one power source;
a wrist fastener configured to fasten a wrist of said user to said arm support of said controller housing having a coil spring and a button-operated fastener; and
wherein said controller housing and said wrist fastener work in functional combination to enable said user to remotely operate an auxiliary device.

2. The electronic controller of claim 1, wherein said controller housing is ergonomically contoured and configured such that said electronic controller is operable via a single hand of said user.

3. The electronic controller of claim 2, wherein said arm support of said controller housing and said wrist fastener work in functional combination to allow said electronic controller to be manipulated and operated absent application of a grasping force of said single hand of said user.

4. The electronic controller of claim 3, wherein said controller housing of said electronic controller is structured to receive an arm of said user such that said electronic controller is suspended from said hand of said user.

5. The electronic controller of claim 4, wherein said controller housing is contoured to ergonomically fit said hand of said user, said thumb-operated directional control pad of said controller housing and said plurality of finger-operated buttons of said controller housing aligned with a positioning of a thumb of said user and at least one finger of said user respectively.

6. The electronic controller of claim 5, wherein said electronic controller is securely fastenable to said arm of said user via said wrist fastener.

7. The electronic controller of claim 6, wherein said thumb-operated directional control pad of said controller housing is operable via said thumb of said user.

8. The electronic controller of claim 7, wherein said plurality of finger-operated buttons of said controller housing are operable by said at least one finger of said user.

9. The electronic controller of claim 8, wherein said plurality of finger-operated buttons of said controller housing are disposed longitudinally on said controller housing such that said user is able to operate said plurality of finger-operated buttons of said controller housing with exactly four fingers.

10. The electronic controller of claim 9, wherein said thumb-operated directional control pad of said controller housing and said plurality of finger-operated buttons of said controller housing comprises input devices for actuating at least one command prompt.

11. The electronic controller of claim 10, wherein said thumb-operated directional control pad of said controller housing and said plurality of finger-operated buttons of said controller housing are operable simultaneously for actuating a range of said command prompts.

12. The electronic controller of claim 11, wherein said thumb-operated directional control pad of said controller housing is arranged perpendicular to said plurality of finger-operated buttons of said controller housing such that said user is able operate said thumb-operated directional control pad of said controller housing via said thumb of said user.

13. The electronic controller of claim 12, wherein said at least one controller processor is configured to process an input to an output, said input comprising an input signal received by said at least one controller processor when one of said input device(s) is actuated by said user operating said electronic controller, said output comprising an output electronic signal.

14. The electronic controller of claim 13, wherein each of said plurality of finger-operated buttons of said controller housing transmits a first input signal if pressed briefly and a second input signal if pressed and held for a programmable period of time.

15. The electronic controller of claim 14, wherein a selection of said input signal(s) includes at least one control parameter as follows:
pressing one of said plurality of finger-operated buttons of said controller housing;
holding one of said plurality of finger-operated buttons of said controller housing for a predetermined period of time; and
pressing one of said thumb-operated buttons of said thumb-operated directional control pad of said controller housing;
wherein said selection of said input signal(s) is dependent on a combination of said at least one control parameter.

16. The electronic controller of claim 15, wherein said at least one controller processor is structured and arranged to transmit said output electronic signal to said auxiliary device by wireless means via a wireless transmitter housed within said inner cavity of said controller housing.

17. The electronic controller of claim 16, wherein said at least one controller processor is structured and arranged to transmit said output electronic signal to said auxiliary device by wired means via a connecting cable in communication between said electronic controller and said auxiliary device.

18. A single-handed input controller, the electronic controller comprising:
a controller housing having;
an arm support configured to support an arm of a user;
a hand aperture configured to receive a hand of said user;
a thumb-operated directional control pad including four thumb-operated buttons;
a plurality of finger-operated buttons;
a power switch configured to activate and deactivate said electronic controller; and
an inner cavity structured and configured to fixedly retain at least one controller processor and at least one power source; and
a wrist fastener configured to fasten a wrist of said user to said arm support of said controller housing having a coil spring and a button-operated fastener;
wherein said controller housing is ergonomically contoured such that said electronic controller is operable via a single hand of said user;
wherein said arm support and said wrist fastener of said controller housing work in functional combination to allow said electronic controller to be retained and operated absent application of a grasping force of said single hand of said user;
wherein said electronic controller is structured to receive and be worn by said arm of said user, said controller housing being suspended from said hand of said user;
wherein said controller housing is contoured to ergonomically fit said hand of said user such that said thumb-operated directional control pad of said controller housing and said plurality of finger-operated buttons of said controller housing are in alignment with a positioning of a thumb of said user and four fingers of said user;
wherein said thumb-operated directional control pad of said controller housing is operable by said thumb of said single hand user;
wherein said plurality of finger-operated buttons of said controller housing are operable by said four fingers of said single hand of said user;
wherein said thumb-operated directional control pad of said controller housing and said plurality of finger-operated buttons of said controller housing are operable simultaneously;
wherein said thumb-operated directional control pad of said controller housing and said plurality of finger-operated buttons of said controller housing comprise input devices for actuating at least one command prompt;
wherein said at least one controller processor translates an input to an output, said input comprising an input signal received by said at least one controller processor when one of said input device(s) is/are actuated by said user operating said electronic controller, said output comprising an output electronic signal communicated to at least one auxiliary device;
wherein said at least one controller processor is structured and arranged to transmit said output electronic signal to an auxiliary device by wireless means via a wireless transmitter housed within said inner cavity of said controller housing, said wireless transmitter powered by said at least one power source; and
wherein said controller housing and said wrist fastener work in functional combination to enable said user to remotely operate said auxiliary device.

19. The electronic controller of claim 18, wherein said controller housing is configured for said single hand comprising a right hand of said user that is right-handed, and alternatively configured for said single hand comprising a left hand of said user that is left-handed.

20. A method of using an electronic controller comprising the steps of:
placing a single hand through a hand aperture of a controller housing of said electronic controller;
aligning an arm with an arm support of said controller housing;
fastening a wrist fastener about a wrist of said user;
selecting one of a plurality of finger-operated buttons of said controller housing; and
pressing one of four thumb-operated buttons of a thumb-operated directional control pad of said controller housing for remotely operating an auxiliary device.
